(19) United States
(12) Patent Application Publication
(10) Pub. No.: US 2009/0070753 A1
(43) Pub. Date: Mar. 12, 2009

(54) INCREASE THE COVERAGE OF PROFILING FEEDBACK WITH DATA FLOW ANALYSIS

(75) Inventors: Tong Chen, Yorktown Heights, NY (US); Alexandre E. Eichenberger, Chappaqua, NY (US); Kathryn O'Brien, South Salem, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/851,589

(22) Filed: Sep. 7, 2007

(51) Int. Cl. G06F 9/45

(52) U.S. Cl. 717/155

(57) ABSTRACT

The present invention provides a system and method for profiling based optimization of a computer program. The system includes an optimization module that profiles feedback from profiled part of a program to a part of the program that was not reached, an identical expressions model that identifies at least one identical expression in the program that have not been profiled and copies alias profiling result from a profiled reference to the reference that has not been profiled, a speculative identical expressions model that identifies at least one speculative identical expression in the program that have not been profiled and copies alias profiling result from a profiled speculative identical reference to the speculative identical reference that has not been profiled, and a similar expressions model that identifies at least one similar expression in the program that have not been profiled and copies alias profiling result from a similar profiled reference to the similar reference that has not been profiled.

### BACKGROUND OF THE INVENTION

1. Field of the Invention

This invention generally relates to methods and apparatus compiler optimization and particularly to a profiling-based optimization mechanism with data flow analysis.

2. Description of Background

The profiling-based optimization is an approach to help compiler optimization. This approach contains two major steps: first, the program is executed and profiled to collect the useful information about program's the runtime behavior; and then the profiling information is fed back to compiler and optimizations are performed based on the feedback. Profiling is able to reveal more attributes of programs, which are difficult, if not impossible, to obtain by static compiler analysis. Therefore, more aggressive or more precise optimizations may be applied with the feedback. The profiling-base optimization has shown significant benefit in many applications.

The profiling can be generated by instrumentation or reading hardware performance counter. The instrumentation is to insert code in the original program to catch the interested events. Reading hardware performance counters can provide the hardware events. The trace of events is processed and recorded as the result of profiling. In order to reduce the overhead of profiling, sampling method is often used to collect statically correct profiling result.

When the profiling result is fed back to compiler, a scheme has to be designed to map the runtime information back to the code in compiler, often before a sequence of optimization. Usually, compiler will maintain the mapping of event among optimization steps.

The information from profiling may not be 100% correct for the next run. Therefore, it should be carefully treated as heuristics to guide compiler making decisions. It is very likely that speculative optimizations can exploit more chances. Speculative optimizations may go wrong sometimes. Corresponding failure detection and recovery code should be generated too.

The profiling-base optimization was started with branch profiling. If compiler is able to predict whether a branch is taken or fall through, many optimizations can applied to transform the code so as to result in higher performance: the code can be reorganized or pre-fetched to reduce the instruction cache miss; instructions can be executed in the branch delay cycles; hyper-blocks can be formed to expose more optimization opportunity. However, it is difficult to predict branches with high accuracy by static compiler analysis. Profiling is used to collect the taken ratio of each branch and then that information is fed back to compiler.

With the merging of data speculation support, the profiling for memory accesses is becoming more and more important. For example, data speculative load is supported on Itanium processor with Advanced Load Address Table (ALAT). Load can be moved across stores which may store to the same address. If they are not accessing the same address, the load latency can be better hidden. Another example is the research in speculative thread, which is a promising way to make use of multi-core processors. Threads can be run in parallel speculatively even when compiler or user can not guarantee there is no dependence among them. The speculative thread support will provide a mechanism for conflict checking and roll back when need. To facilitate these hardware support for data speculation, guidance is needed to choose which references should be speculated with high success rate. Memory profiling can serve for this purpose.

One example of memory access profiling is the alias profiling. When a memory object can be referenced with different forms of expressions, those expressions are called aliases. Alias problem is common in languages using pointers, like C and C++. Alias information is the foundation for data flow analysis and all the optimization upon it. A common alias analysis is to find out all the possible points-to targets for pointers by tracing the pointer assignment and, usage in the control flow graph. However, the static analysis may not produce precise points-to set due to the limitation of algorithm or resource. Alias profiling can collect precise points-to set for a particular input set by using identifying the target through the address value of a reference. Alias profiling has been used in many optimizations and demonstrated its effectiveness.

One concern about profiling-base optimization approach is the coverage issue. Usually, the profiling step uses a much smaller test dataset to run the program so that the profiling can be done quickly. It is possible that the test data set only reached a small portion of the program and compiler still, does not have any information about the un-reached part. To solve this problem, the test dataset is carefully designed for some benchmarks (for example SPEC benchmarks). However, it is not always feasible to build such test dataset. Some large real applications may have a huge number of possible paths.

Another approach is to use continuous profiling. The profiling is continuously sampling the application. New profiling information can be generated when code enters a new portion. The compiler optimizations are applied online. The continuous profiling is able to overcome the coverage problem. However, it requires the dynamic optimization environment, which is a complicated infrastructure, is more difficult to debug, and may exhibit less predictable behavior (a critical component for real time systems).

Currently, in profiling-based optimization, the profiling coverage is a problem for some applications that different input sets reach substantially different parts of the whole program. Only the reached parts in the program in the profiling run(s) will obtain profiling result and may be better optimized. The other parts, which are likely to be executed with other input sets, can not benefit from the profiling-based optimization. This coverage problem may limit the effectiveness of profiling-based optimization.

For online profiling-based optimization, the current solution is to use continuous profiling and dynamic optimization. The profiling tool keeps collecting the behavior of the application. When the program enters a path that, has not been optimized, the optimization is invoked dynamically. Though this approach is able to solve the coverage problem and even the phase changing problem, it has the drawbacks of complexity in whole system, runtime overhead for contentious profiling and dynamic optimization, as well as the response lap between profiling and optimization.

### SUMMARY OF THE INVENTION

Embodiments of the present invention provide a system and method for profiling-based optimization of a computer program. The system includes an optimization module that propagates feedback from profiled part of a program to a part of the program that was not reached. The optimization module further comprises an identical expressions model that identifies at least one identical expression in the program that have not been profiled and copies alias profiling result from a profiled reference to the reference that has not been profiled, a speculative identical expressions model that identifies at least one speculative identical expression in the program that have not been profiled and copies alias profiling result from a profiled speculative identical reference to the speculative identical reference that has not been profiled, and a similar expressions model that identifies at least one similar expression in the program that have not been profiled and copies alias profiling result from a similar profiled reference to the similar reference that has not been profiled

Embodiment of the present invention can also be viewed as providing methods for profiling-based optimization of a computer program. In this regard, one embodiment of such a method, among others, can be broadly summarized by the following steps. The method operates by (1) profiling feedback from profiled part of the program to a part of the program that was not reached, (2) identifying at least one identical expression in the program that have not been profiled and copies alias profiling result from a profiled reference to the reference that has not been profiled, (3) identifying at least one speculative identical expression in the program that have not been profiled and copies alias profiling result from a profiled speculative identical reference to the speculative identical reference that has not been profiled; and (4) Identifying at least one similar expression in the program that have not been profiled and copies alias profiling result from a similar profiled reference to the similar reference that has not been profiled.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer utilizing the profiling based optimization system of the present invention.

FIG. 2 is a flow chart illustrating an example of the operation of program code optimization using the profiling based optimization of the present invention.

FIG. 3 is a flow chart illustrating an example of the operation of the profiling based optimization system of the present invention, as shown in FIGS. 1 and 2.

FIG. 4 is a flow chart illustrating an example of the operation of the identical expressions module on the computer that is utilized in the profiling based optimization system of the present invention, as shown in FIGS. 1 and 2.

FIG. 5 is a flow chart illustrating an example of the operation of the speculative identical expressions module on the computer that is utilized in the profiling based optimization system of the present invention, as shown in FIGS. 1 and 2.

FIG. 6 is a flow chart illustrating an example of the operation of the similar expressions module on the computer that is utilized in the profiling based optimization system of the present invention, as shown in FIGS. 1 and 2.

The detailed description explains the preferred embodiments of the invention, together with advantages and features, by way of example with reference to the drawings.

### DETAILED DESCRIPTION OF THE INVENTION

The invention addresses problems with coverage. Coverage is a hard problem for control flow because it is difficult to infer behavior of un-reached the branch from the reached branch. However, the situation for memory profiling is different: a variable in the un-reached branches should have the same value as the value at the entrance of the branch, until it is modified. This forms the ground for us to propagate the memory profiling information to the un-reached part of program.

Traditional use of profiling information is made following the control flow of a program, as constructed by the code optimization tool. The present invention extends this prior art with the novel concept and associated mechanisms to propagate the profiling information, leading the improvements of the profiling efficiency. The concept of propagating data profile information into the not reached part of a program has not been practiced before.

The present invention consists of new optimization step inside a code optimization tool (i.e. such as a compiler) based on extensions to the usage of profiling information. The present invention requires only code development within the optimization tool.

For some profiling techniques, such as alias profiling, it is feasible to use static data flow analysis to propagate the profiling results into the unreached parts. The alias information on some references in unreached parts can be inferred from the similar references that alias profiling has reached based on the data flow of the program. The flow here is started from feedback points and is bi-directional (both forwards and backwards). Heuristics are used to increase the propagation range when expressions are not exactly the same. Further more, the data flow of the program can be based on the alias profiling result to be more aggressive. That is the kills in the data flow are based on the alias profiling feedback instead of static analysis. Some kills from static analysis may be ignored. In this way, the offline profiling-based optimization can reduce the coverage problem.

The alias profiling feedback provide the value of two functions, is_reached( ) and target_set( ) for each reference in the program: for each expression, exp, is_reached (exp) is TRUE if this expression is reached at runtime during a profiling run, otherwise FALSE. When is_reached(exp) is TRUE, target_set(exp) is the set of targets referenced by this expression at runtime. Otherwise, target_set(exp) is NULL.

In implementation, is_reached can be eliminated because is_reached (exp)=FALSE is equivalent to target_set (exp)=NULL. Both functions are kept here for better illustration. The goal is to calculate the target_set for is_reached is FALSE. Call the calculated target set is target_set_p.

To simplify the description, it is assumed that the program has been in Static Single Assignment (SSA) form based on the static analysis. However, the present invention is not limited to SSA form. All the information can be calculated from original programs.

1. Propagate to the identical expressions in both forward and backward direction.

### EXAMPLE 1a

if(cond1 )

r1 =*(p1 +k2) . . .

if(cond2)

r2=*(p1 +k2)

### EXAMPLE 1b

if(cond2 )

r1 =*(p1 +k2) . . .

if(condl )

r2=*(p1 +k2)

In example 1a, assume that for reference r1, *(p1+k2), is_reached(r1) is TRUE while for reference r2, *(p1+k2), is_reached(r2) is FALSE. This will happen if the second branch conditional on cond2 is never taken during the profiling run. It can be determined that the two references are identical: both are indirect reference of p1+k2 and p1+k2 are identical. In SSA form, if the references to the same variable should have the same value. Therefore, it is possible to propagate the alias profiling result of reference r1 to reference r2. That is target_set_p(r2)=target_set(r1). In example 1b, assume that for reference r2, *(p1+k2), is_reached(r2) is TRUE while for reference r1, *(p1+k2), is_reached(r1) is FALSE. Despite of the reversed order, we can still propagate the profiling result.

2. Propagate to speculatively identical expressions. Since the static alias analysis in a compiler may be very conservative (that's why alias profiling is needed), extra variable versions might be introduced and consequently reduce the number of identical expressions. For example in example 2, references r1 and r3 are originally indirect referring variable p, and is_reached(r1)=TRUE but is_reached(r3)=FALSE.

### EXAMPLE 2

r1 =*p1

. . .

r2 *q=

. . .
if(cond)

r3 =*p2

Compiler's alias analysis says that p and *q are aliased so r1 and r3 are given different version number in SSA form. Now they are different, so can not propagate target_set(r1) to reference r2.

However, it is possible to rely more on alias profiling. If the target_set(r2) is available, it can check whether p is in target_set(r2). If yes, r1 and r3 are different expressions. If no, they are identical speculatively based on alias profiling. Therefore we can let target_set_p(r3)=target_set(r1).

3. Propagate to similar expressions. The propagation to identical expressions is precise but may lose opportunities. Heuristics can be used to propagate alias profiling feedback to similar expressions. Different heuristic rule may provide results with different precision for applications. The heuristic rules can be: Assume there is a primary pointer in the address part; and ignore some parts in the expression.

### EXAMPLE 3

if(cond1 )

r1 =*(q+m)

. . .
if(cond2)

r2 =*(q+k+3)

If q is of pointer type, it maybe assumed that q is the primary pointer in the address part of expressions r1 and r2. We may ignore the other portion of the expressions and regarded r1 and r2 are similar expressions. Therefore, the alias profiling result can be shared between these two references.

4. Propagate interproceduraly. Example 4 is the typical case in real applications: for one input set, function foo_{—}1 is called, and for another, function foo_{—}2 is called. Assume that foo_{—}1 is called but foo_{—}2 is not in profiling. Inter-procedural propagation is needed.

### EXAMPLE 4

foo_0 ( ) {

. . .
switch(c) {
case 1:

foo_1(p);
break;

case 2:

foo_2(p);
break;

}

. . .
}
foo_1(p) {

. . .
=*p

}
foo_2(p) {

. . .
=*p
. . .

In foo_{—}1, the target_set(*p) is propagated backwards to the entrance of this function if there is no kill of variable p. Bottom-up in the call graph, target_set(*p) is propagated to this call site of foo_{—}1. In foo_{—}0, determine whether p in parameter of foo_{—}1 and foo_{—}2 is the same. If yes, propagate target_set(*p) from foo_{—}1 to foo_{—}2

In foo_{—}2, the target_set(*p) is propagated forwards to the reference if there is no kill between the entrance and the reference. For interprocedural propagation, either context-sensitive or context-insensitive method can be used.

All the methods discussed above can be integrated together. The integration can be customized based on the choice between precision and overhead. In general, the algorithm is an iterative data flow analysis. Each iteration will propagate at least one target_set to one reference. Since there are limited number of references and target_set, the whole process will terminate.

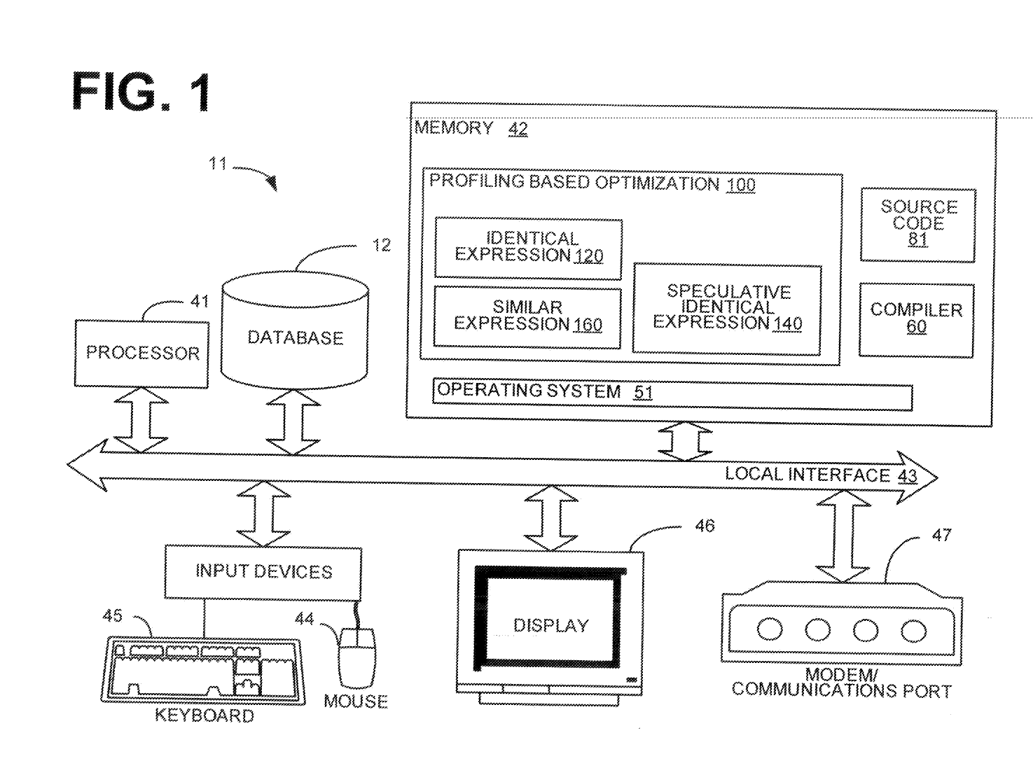

FIG. 1 is a block diagram illustrating an example of a computer 11 utilizing the Profiling based optimization system 100 of the present invention. Computer 11 includes, but is not limited to, PCs, workstations, laptops, PDAs, palm devices and the like. Generally, in terms of hardware architecture, as shown in FIG. 1, the computer 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the computer 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 1, the software in the memory 42 includes a suitable operating system (O/S) 51, compiler 60, source code 81 and the profiling based optimization system 100 of the present invention. As illustrated, the profiling based optimization system 100 of the present invention comprises numerous functional components including, but not limited to, the identical expressions module 120, speculative identical expressions module 140 and similar expressions module 160.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a Linux operating system, which is freeware that is readily available on the Internet; (e) a run time Vxworks operating system from WindRiver Systems, Inc.; or (f) an appliance-based operating system, such as that implemented in handheld computers or personal data assistants (PDAS) (e.g., Symbian OS available from Symbian, Inc., PalmOS available from Palm Computing, Inc., and Windows CE available from Microsoft Corporation).

The operating system 51 essentially controls the execution of other computer programs, and provides scheduling, input-output control, file and data management, memory management, and communication control and related services. It is contemplated by the inventors that the profiling based optimization system 100 of the present invention is applicable on all other commercially available operating systems.

The profiling based optimization system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the Profiling based optimization system 100 can be written as (a) an object oriented programming language, which has classes of data and methods, or (b) a procedure programming language, which has routines, subroutines, and/or functions, for example but not limited to C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the computer 11 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the computer 11 is activated.

When the computer 11 is in operation, the processor 41 is configured to execute software stored within the memory 42, to communicate data to and from the memory 42, and to generally control operations of the computer 11 are pursuant to the software. The profiling based optimization system 100 and the O/S 51 are read, in whole or in part, by the processor 41, perhaps buffered within the processor 41, and then executed.

When the profiling based optimization system 100 is implemented in software, as is shown in FIG. 1, it should be noted that the profiling based optimization system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The profiling based optimization system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary and then stored in a computer memory.

In an alternative embodiment, where the profiling based optimization system 100 is implemented in hardware, the profiling based optimization system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

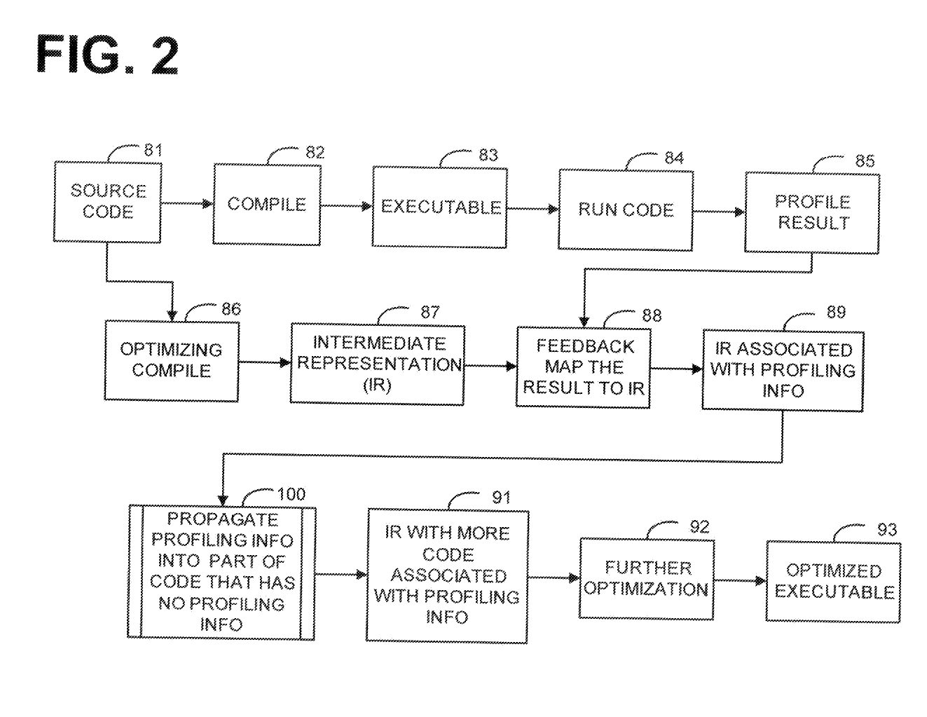

FIG. 2 is a flow chart illustrating an example of the operation of program code 81 optimization using the profiling based optimization of the present invention. Optimization of the compiled source code 81 occurs after the compilation process.

First, the source code 81 is compiled, utilizing compiler 60 at step 82. The executable object code shown in 83 represents an instrumented executable object that will be used to gather profiling instruction. At step 84, the executable code is run. At step 85, a profile is extracted from running the profiled code created at 84. This profile data can be used in further optimization steps.

At step 86, source code 81 is fed into an optimization compiling process. From this optimizing compile, an intermediate representation of the optimized compiled code is generated at step 87. At step 88, the profile result created at step 85 and the intermediate representation code created at 87 are used to create the feedback map. From the feedback map the intermediate representation is associated with the profiling information at step 89.

From this intermediate representation of the source code 81 along with the profiling information is fed into the profile based optimization system at step 100. It is the profiling based optimization, is the subject of the present invention. At step 100, the profiling based information is propagated into parts of the run code that have no profiling information.

At step 91, the intermediate representation is associated with more code with the profiling information generated at step 100. At step 92, further optimization is performed on the run code to produce the optimized executable code at step 931

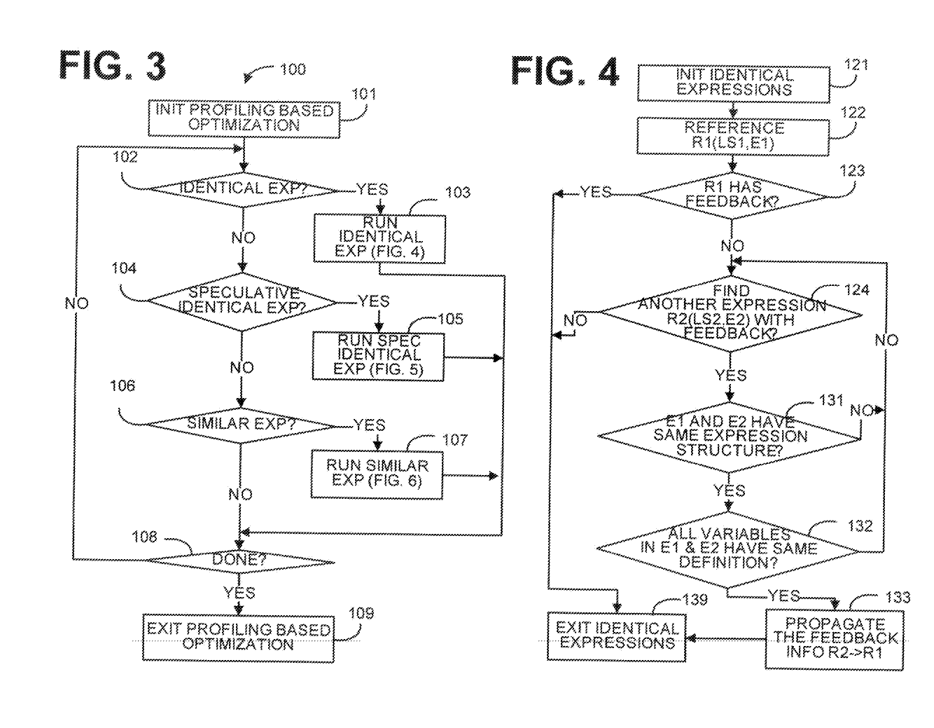

FIG. 3 is a flow chart illustrating an example of the operation of the profiling based optimization system 100 of the present invention, as shown in FIGS. 1 and 2. The profiling based optimization system 100 can propagate the profiling information, leading the improvements of the profiling efficiency.

First at step 101, the profiling based optimization system 100 is initialized. This initialization may include startup routines and processes embedded in the BIOS of the computer 11. The initialization also includes the establishment of data values for particular data structures utilized in the profiling based optimization system 100.

At step 102, the profiling based optimization system 100 determines if an identical expressions profiling is to be performed. If it is determined that the identical expression profiling is not to be performed, then the profiling based optimization system 100 skips to step 104. However, if it is determined at step 102 that an identical expression profiling is to be performed, then the profiling based optimization system 100 runs the identical expression module at step 103. The identical expression module is herein defined in further detail with regard to FIG. 4. The profiling based optimization system 100 skips to step 108.

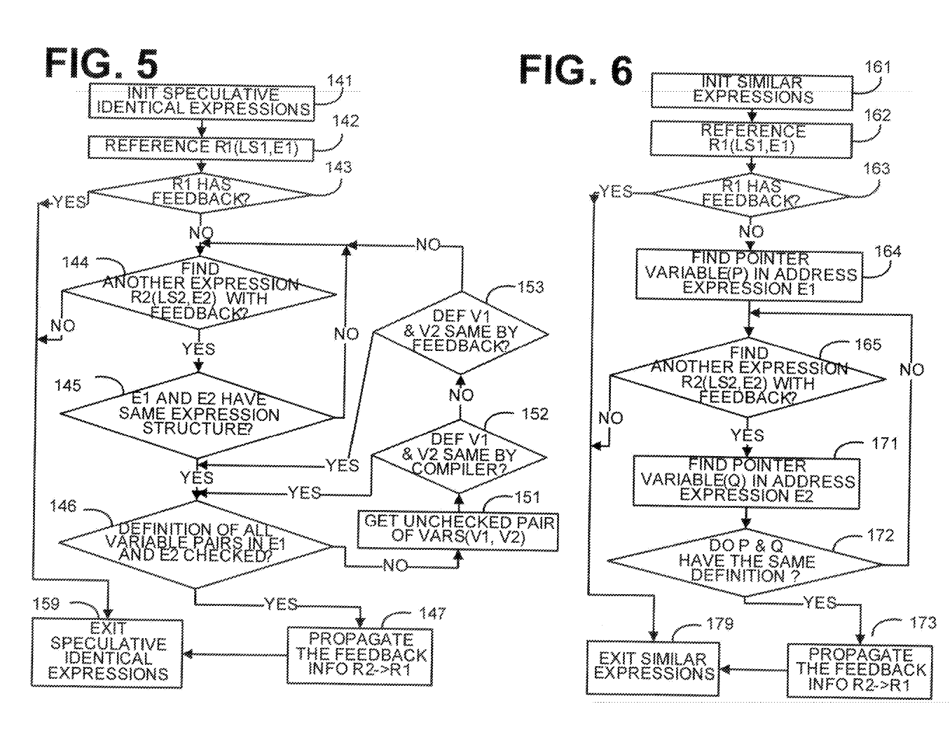

At step 104, the profiling based optimization system 100 determines if a speculative identical expressions profiling is to be performed. If it is determined that the speculative identical expression profiling is not to be performed, then the profiling based optimization system 100 skips to step 106. However, if it is determined at step 104 that the speculative identical expression profiling is to be performed, then the profiling based optimization system 100 runs the speculative identical expression module at step 105. The speculative identical expression module is herein defined in further detail with regard to FIG. 5. The profiling based optimization system 100 gives to step 108.

At step 106, the profiling based optimization system 0.100 determines if similar expressions profiling is to be performed. If it is determined that the similar expression profiling is not to be performed, then the profiling based optimization system 100 skips to step 108. However, if it is determined at step 106 that a similar expression profiling is to be performed, then the profiling based optimization system 100 runs the similar expression module at step 107. The similar expression module is herein defined in further detail with regard to FIG. 6. The profiling based optimization system 100 skips to step 108.

At step 108, the profiling based optimization system 100 determines if there are more expressions to be profile. If it is determined at step 108 that there are more up expressions to be profiled, then the profiling based optimization system 100 returns to repeat steps 102 through 108. However, if it is determined at step 108 that there are no more expressions to be processed, then the profiling based optimization system 100 of the present invention then exits at step 109.

FIG. 4 is a flow chart illustrating an example of the operation of the identical expressions module 120 on the computer that is utilized in the profiling based optimization system of the present invention, as shown in FIGS. 1 and 2. The profiling based optimization system 100 of the present invention can propagate to the identical expressions in both forward and backward direction.

First at step 121, the identical expressions module 120 is initialized. This initialization may include startup routines and processes embedded in the BIOS of the computer 11. The initialization also includes the establishment of data values for particular data structures utilized in the identical expressions module 120.

At step 122, the identical expressions module 120 identifies a reference R1. A reference R1 consists of a pair of two fields. The first field, referred to as LS1, and determines if R1 is associated with a load or a store. The second field, referred to as address expression E1, indicates the memory location is to be loaded or stored by the reference R1. In the drawing, referred to a reference as R1 (LS1, E1) where the pair of fields associated with reference R1 are explicitly listed as LS1 and E1.

At step 123, it is determined in the reference R1 has feedback. The feedback step attaches profiling results to reference R1, and that means it is likely to access variables attached to reference R1. If it is determined at step 123 at the reference R1 does have feedback and the identical expressions module 120 then exits at step 139.

However, if it is determined at step 123 that R1 does not have feedback, the identical expressions module 120 then tries to find another expression R2 with feedback at step 124. If the identical expressions module 120 does not find another expression R2 with feedback at step 124, then the identical expressions module 120 then exits at step 139.

However, if the identical expressions module 120 does find another expression R2 with feedback at step 124, then the identical expressions module 120 finds E1 and E2 for the address expression of R1 and R2 and then check whether E1 and E2 have the same expression structure at step 131. If it is determined at step 131 that E1 and E2 do not have the same expression structure, then the identical expressions module 120 returns to repeat step 124. A reference may be a load or store. The address expression for a reference is the expression to calculate the address for the load or store. The system can propagate profiling information among loads and stores. What is important is their address expression, not what operation a reference is to perform. In the high level intermediate representation, the address expression can be directly found. Forward substitution will expose more information about address expressions.

However, if it is determined at step 131 that E1 and E2 have the same expression structure, then the identical expressions module 120 tests to see if all the variables in reference expression number E1 and E2 have the same definition at step 132. If it is determined at step 132 that all variables in R1 and R2 do not have the same definition, then the identical expressions module 120 returns to repeat step 124. How the same expression structure is determined is as follows. It is a recursive process to determine whether two expressions have the same structure. From the top level of the expressions, if their operators are different, they do not have the same structure. If the operators are the same, further check where each of the operands are the same. If the operands are constant, or variables, they can be compared directly. If the operands are expression, the process can be invoked recursively. Only when each of the operands in the two expressions are the same, the two expressions have the same structure. For commutable operators, all combinations of the operand order are checked.

However, if it is determined that all pairs of variables in E1 and E2 do have the same definition, and then the identical expressions module 120 propagates the feedback information from R2 into R1. The variables in the same position in the expression in E1 and E2 form a pair to be checked. It is assume that conventional Def-Use analysis has been performed on the program. A variable appearing in the address expression is a use. Its definition can be found from the def-use chain. It is easy to compare whether two variables point to the same definition or not.

The identical expressions module 120 then exits at step 139.

FIG. 5 is a flow chart illustrating an example of the operation of the speculative identical expressions module 140 on the computer that is utilized in the profiling based optimization system 100 of the present invention, as shown in FIGS. 1 and 2. Propagate to speculatively identical expressions, since the static alias analysis in a compiler may be very conservative (that's why alias profiling is needed), extra variable versions might be introduced and consequently reduce the number of identical expressions.

First at step 141, the speculative identical expressions module 140 is initialized. This initialization may include startup routines and processes embedded in the BIOS of the computer 11. The initialization also includes the establishment of data values for particular data structures utilized in the speculative identical expressions module 140.

At step 142, the speculative identical expressions module 140 identifies a reference R1. A reference R1 consists of a pair of two fields. The first field, referred to as LS1, and determines if R1 is associated with a load or a store. The second field, referred to as address expression E1, indicates the memory location is to be loaded or stored by the reference R1. In the drawing, referred to a reference as R1(LS1, E1) where the pair of fields associated with reference R1 are explicitly listed as LS1 and E1.

At step 143, it is determined in the reference R1 has feedback. The feedback step attaches profiling results to reference R1, and that means it is likely to access variables attached to reference R1. If it is determined at step 143 at the reference R1 does have feedback and the speculative identical expressions module 140 then exits at step 159.

However, if it is determined at step 143 that R1 does not have feedback, the speculative identical expressions module 140 then attempts to find another expression R2 with feedback at step 144. If the speculative identical expressions module 140 does not find another expression R2 with feedback at step 144, then the speculative identical expressions module 140 then exits at step 159.

However, if the speculative identical expressions module 140 does find another expression R2 with feedback at step 145, then the speculative identical expressions module 140 finds E1 and E2 for the address expression for R1 and R2 and checks whether E1 and E2 have the same expression structure at step 145. The expression structure was defined above with regard to FIG. 4. If it is determined that E1 and E2 do not have the same expression structure then they are not speculatively identical, the speculative identical expressions module 140 then returns to repeat step 144.

However, if it is determined at step 145 that E1 and E2 have the same expression structure, then it is determined if the definition of all variable pairs in E1 and E2 have been checked at step 146. This checks whether the pair of variables has same definition in conventional data flow. If it is determined that all the variable pairs in E1 and E2 have not been checked, then the speculative identical expressions module 140 proceeds to step 151.

However, if it is determined that all the variable pairs in E1 and E2 have been checked, then the speculative identical expressions module 140 propagates the feedback information from R2 into R1 at step 147 and proceeds to exit at step 159.

At step 151, the speculative identical expressions module 140 gets a pair of variables (V1, V2) at step 151. At step 152, it is determined if the definition of the E1 and E2 are the same by the compiler 60 (FIG. 1). This checks whether the different definition is caused by speculatively ignored kill. Compiler 60 may conservatively assume may kills in the program due to weak alias analysis. If it is determined at step 152 that the definition of E1 and E2 are the same by compiler 60, then the speculative identical expressions module 140 returns to repeat step 146.

However, it is determined at step 152 that the definition of E1 and E2 are not the same definition by the compiler 60, then the speculative identical expressions module 140 then determines if V1 and V2 are the same definition by feedback at step 153. This checks if a write reference, r, does not contain a variable in its feedback target_set. It can speculatively think the reference r is not a kill for that variable, because it is likely that this reference never modify that variable. Moreover, if elements in the feedback target_set are associated with possibility information, it can make the decision based on the possibility and a threshold. Speculatively ignore the kill for a variable is the possibility for the variable in the target_set is less than the threshold. Maximum or addition may be used for accumulate the possibility when the control flow paths merge

It is determined at step 153 that the definition of E1 and E2 are the same definition by feedback, then the speculative identical expressions module 140 then returns to repeat step 146. However, if it is determined at step 153 that the definition of V1 and V2 are not the same by feedback, then the speculative identical expressions module 140 returns to repeat step 144.

The speculative identical expressions module 140 then exits at step 159.

FIG. 6 is a flow chart illustrating an example of the operation of the similar expressions module on the computer that is utilized in the profiling based optimization system of the present invention, as shown in FIGS. 1 and 2. The propagation to identical expressions is precise but may lose opportunities. Heuristics can be used to propagate alias profiling feedback to similar expressions.

First at step 161, the similar expressions module 160 is initialized. This initialization may include startup routines and processes embedded in the BIOS of the computer 11. The initialization also includes the establishment of data values for particular data structures utilized in the similar expressions module 160.

At step 162, the similar expressions module 160 identifies a reference R1. A reference. R1 consists of a pair of two fields. The first field, referred to as LS1, and determines if R1 is associated with a load or a store. The second field, referred to as address expression E1, indicates the memory location is to be loaded or stored by the reference R1. In the drawing, referred to a reference as R1(LS1, E1) where the pair of fields associated with reference R1 are explicitly listed as LS1 and E1.

At step 163, it is determined in the reference R1 has feedback. The feedback step attaches profiling results to reference R1, and that means it is likely to access variables attached to reference R1. If it is determined at step 163 at the reference R1 does have feedback and the similar expressions module 160 then exits at step 179.

However, if it is determined at step 163 that R1 does not have feedback, the similar expressions module 160 then finds the pointer variable in the address of R1 (P) at step 164. At step 165, these similar expressions module 160 then tries to find another expression R2 with feedback. If the similar expressions module 160 does not find another expression R2 with feedback at step 165, then the similar expressions module 160 then exits at step 179.

However, if the similar expressions module 160 does find another expression R2 with feedback at step 165, then the similar expressions module 160 finds the pointer variable in the address of R2(Q) at step 171.

At step 172, the similar expressions module 160 then determines if the pointer variable in the address of R1 (P) has the same definition as the pointer variable in the address of R2(Q). If it is determined that P and Q do not have the same definition, then the similar expressions module 160 returns to repeat step 165.

However, if it is determined that P and Q do have the same definition, then the similar expressions module 160 propagates the feedback information from R2 into R1, at step 173.

The similar expressions module 160 then exits at step 179.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A profiling based optimization system, the system comprising:
a optimization module that profiles feedback from a profiled part of a program to a part of the program that was not reached, the optimization module further comprising;
a identical expressions model that identifies at least one identical expression in the program that have not been profiled and copies alias profiling result from a profiled reference to the reference that has not been profiled;
a speculative identical expressions model that identifies at least one speculative identical expression in the program that have not been profiled and copies alias profiling result from a profiled speculative identical reference to the speculative identical reference that has not been profiled; and
a similar expressions model that identifies at least one similar expression in the program that have not been profiled and copies alias profiling result from a similar profiled reference to the similar reference that has not been profiled.

2. The system of claim 1, wherein the profiling based optimization system operates in a forward and in a backward direction.

3. The system of claim 1, wherein the profiling based optimization system is based upon static data flow and feedback.

4. The system of claim 1, wherein the least one similar expression and the similar profiled reference are determined to be similar if each have a pointer type variable that have a common definition, and were the reset of the expression is ignored.

5. The system of claim 1, wherein a plurality of variables in address expressions of the at least one speculative identical expression and the profiled speculative identical reference have the same definition point after at least one definition, which are assumed by compiler data flow analysis, are ignored with respect of the profiling results.

6. A method for profiling based optimization of a computer program, comprising:
profiling feedback from profiled part of the program to a part of the program that was not reached;
identifying at least one identical expression in the program that have not been profiled and copies alias profiling result from a profiled reference to the reference that has not been profiled;
identifying at least one speculative identical expression in the program that have not been profiled and copies alias profiling result from a profiled speculative identical reference to the speculative identical reference that has not been profiled; and
identifying at least one similar expression in the program that have not been profiled and copies alias profiling result from a similar profiled reference to the similar reference that has not been profiled.

7. The method of claim 6 wherein the profiling based optimization system is based upon static data flow and feedback.

8. The method of claim 6, wherein the profiling based optimization system is based upon static data flow and feedback.

9. The method of claim 6, wherein the least one similar expression and the similar profiled reference are determined to be similar if each have a pointer type variable that have a common definition, and were the reset of the expression is ignored.

10. The method of claim 6, wherein a plurality of variables in address expressions of the at least one speculative identical expression and the profiled speculative identical reference have the same definition point after at least one definition, which are assumed by compiler data flow analysis, are ignored with respect of the profiling results.
